(19) United States
(12) Patent Application Publication
(10) Pub. No.: US 2009/0119070 A1
(43) Pub. Date: May 7, 2009

(54) Method and apparatus for investigation of how a technical system can be broken down

(75) Inventor: Thomas Glau, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/911,480

(22) PCT Filed: Apr. 12, 2006
(86) PCT No.: PCT/EP06/03350

§ 371 Date: May 21, 2008

(30) Foreign Application Priority Data
Apr. 13, 2005 (DE) 10 2005 016 911.2
May 4, 2005 (DE) 10 2005 020 822.3

(51) Int. Cl. G06F 17/50; G06T 17/40; G05B 19/418; B23P 21/00

(52) U.S. Cl. 703/1

(57) ABSTRACT

A method, a computer program product and to a data processing installation are provided for investigation of how a technical system which is composed of components can be broken down. Design models of this system and of its components are predetermined. Rays which originate from selected foot points on the surface of the design model are calculated for each component design model. The process determines how many rays which start at the foot point and run in the direction of the predetermined direction vectors meet the design model of at least one other component. Each component is weighted as a function of these numbers. The result is determined that the component with the highest weighting can be removed from the system.

### CROSS REFERENCE TO RELATED APPLICATIONS

This application is a continuation of PCT International Application No. PCT/EP2006/003350, filed Apr. 12, 2006, which claims priority under 35 U.S.C. § 119 to German Patent Application Nos. 10 2005 016 911.2, filed Apr. 13, 2005, and 10 2005 020 822.3, filed May 4, 2005, the entire disclosures of which are herein expressly incorporated by reference.

### BACKGROUND AND SUMMARY OF THE INVENTION

The invention relates to a method, to a computer program product and to a data processing installation for determining how a technical system which is composed of components can be broken down.

One application of a method such as this is automatic generation of an exploded drawing of the system. Methods and apparatuses for generation of an exploded drawing are known from EP 1288868 A2 and U.S. Pat. No. 6,295,063 B1. The methods and apparatuses disclosed there are dependent on a movement direction being predetermined for each component. The component can be removed from the system in this predetermined movement direction.

A method and an apparatus are known from H. Srinivasan, N. Shyamsundar & R. Gadh: “A Virtual Disassembly Tool to support Environmentally Conscious Product Design”, Proceed. 1997 IEEE Internat. Symp. On Electronics and the Environment (ISEE-1997), pp. 7-12. Computer-available design models of the components of the technical system to be investigated, as well as a plurality of directions, are predetermined. The document describes how to determine whether and when a component can be removed from a technical system, and in which of these directions. The document does not disclose how a data processing installation carries this out automatically for complex technical systems as well.

US 2003/0004908 A1 discloses a method to allow a maintenance technician to investigate a technical installation. A sequence in which the installation can be broken down into its components is determined.

The present invention provides a method for automatic investigation of how a technical system can be broken down in which the direction in which a component can be removed from the system is automatically determined, even for a complex technical system.

The method requires only the design models of the system and of its components, but no information about the type of respective component, about the actual sequence for assembly of or breaking down the system, about mechanical degrees of freedom of the components, about rotation axes and about connection elements or connection methods used. In particular, there is no need to predetermine those directions in which the components are moved in order to break down the system. If directions such as these had to be predetermined, a manual input would be necessary which requires time, and is associated with errors. The method according to the invention therefore saves time in comparison to known methods for generation of an exploded drawing, and avoids errors.

The method does not require a component to have already been physically produced. The method can therefore be used at an early stage in the product design process.

### BRIEF DESCRIPTION OF THE DRAWING FIGURES

One exemplary embodiment of the invention will be described in more detail in the following text with reference to the attached figures, in which:

FIG. 1 shows an exploded drawing;

FIG. 2 shows the selection of foot points;

FIG. 3 shows the calculation of rays for a direction vector;

FIG. 4 shows the calculation of the weighting of two design models with respect to two direction vectors;

FIG. 5 shows a flowchart for carrying out the method repeatedly.

### DETAILED DESCRIPTION

In the exemplary embodiment, the method is used in order to generate a perspective exploded drawing of a technical system. The system is composed of the r components Bt(1), Bt(2), . . . , Bt(r). By way of example, the system is a subsystem in a motor vehicle and the r components are the r components of which this subsystem is composed. The exploded drawing to be generated shows those components of which the system is composed, from a specific predetermined viewing direction. The exploded drawing shows the relative positions of the components with respect to one another, so that their orientation reference with respect to one another can be seen.

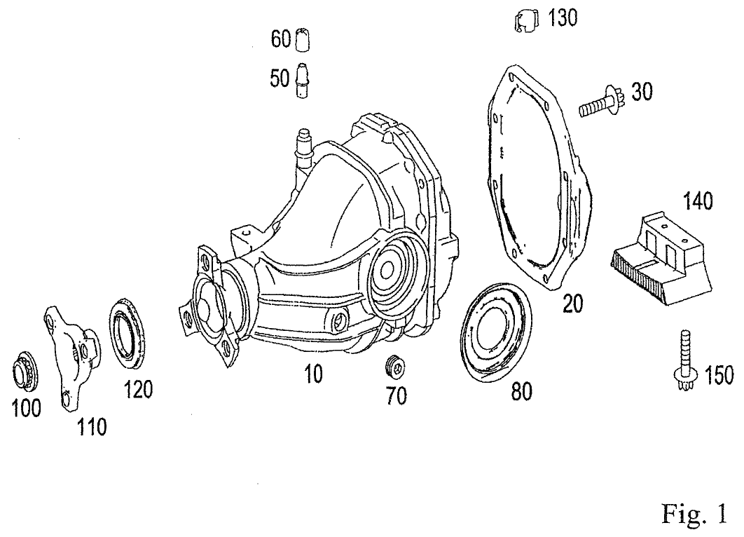

By way of example, FIG. 1 shows an exploded drawing generated according to the invention. This shows the components 10, 20, 30 . . . of a transmission as the system, from a specific viewing direction.

A computer-available design model of the system as well as in each case one computer-available three-dimensional design model KM(k) of each component Bt(k) in the system (k=1, . . . , r) are predetermined. Each design model KM(k) of a component Bt(k) defines at least the geometry of the surface of the component. By way of example, the design model KM(k) describes the surface approximately by means of triangular and/or quadrilateral surface elements. By way of example, these surface elements are bounded by node points, with the node points being defined by a network of the surface, using the finite element method. The finite element method is known, for example, from “Dubbel-Taschenbuch für den Maschinenbau” [Manual for machine construction], 20th edition, Springer-Verlag, 2001, C 48 to C 50. It is also possible for the surface elements to be produced as follows: the components are described by free-form surfaces using a design tool. These free-form surfaces are linearly approximated, resulting in triangular surface elements.

The design model KM of the system defines the positions of the components in the system relative to one another. The design model KM of the system is associatedly linked with the r design models KM(k) (k=1, . . . , r) of the components, so that the component design models can be processed and amended independently of one another. The design model KM of the system can be processed and amended independently of the component design models.

The design model of the system is preferably associated with a three-dimensional Cartesian coordinate system, which is covered by three vectors \vec{x}, \vec{y} and \vec{z} in the direction of the coordinate axes. These three vectors \vec{x}, \vec{y} and \vec{z} are at right angles to one another in pairs, and are predetermined as direction vectors for the method. The three opposite vectors −\vec{x}, −\vec{y} and −\vec{z} are predetermined as further direction vectors for the method. The vector −\vec{x} points in the opposite direction to \vec{x} and is of precisely the same length as it. Further direction vectors can be predetermined for the method, for example
the six vectors \vec{x}+\vec{y}, \vec{x}+\vec{z}, \vec{y}+\vec{z}, −\vec{x}−\vec{y}, −\vec{x}−\vec{z} and −\vec{y}−\vec{z},
the six vectors \vec{x}−\vec{y}, \vec{x}−\vec{z}, \vec{y}−\vec{z}, \vec{y}−\vec{x}, \vec{z}−\vec{x} and \vec{z}−\vec{y}
and/or the eight additional vectors \vec{x}+\vec{y}+\vec{z}, \vec{x}+\vec{y}−\vec{z}, \vec{x}−\vec{y}+\vec{z}, \vec{x}−\vec{y}−\vec{z}, −\vec{x}−\vec{y}+\vec{z} and −\vec{x}−\vec{y}−\vec{z}.

In total, n direction vectors [symbol] are predetermined for the method.

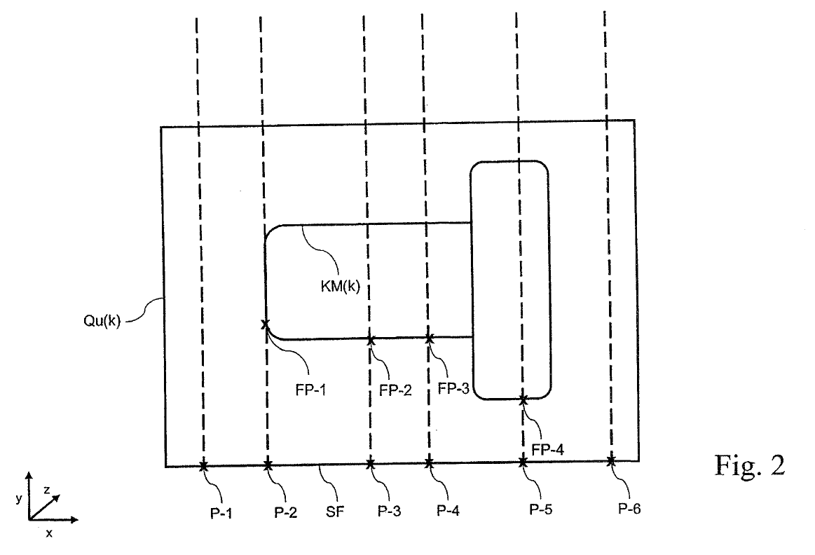

Foot points on the surface of the component design model KM(k) are selected for the design model KM(k) of each component Bt(k). One possibility is to directly select node points for the break down as mentioned above. These node points are defined by breaking down the surface of the design model KM(k) into surface elements. However, in this version, the selection of the foot points is highly dependent on the respective break down. A different approach is therefore preferably adopted, as described in the following text and illustrated in FIG. 2.

A cuboid Qu(k) is determined, which completely envelops the component design model KM(k) and whose edges run parallel to in each case one axis of the coordinate system (k=1, . . . , r). Each of the twelve edges of the cuboid Qu(k) is therefore either parallel to \vec{x}, parallel to \vec{y} or parallel to \vec{z}. The cuboid can be the minimum envelop of the design model KM(k). However, it is also possible to define a cuboid Qu(k) which is larger than the minimum enveloping cuboid.

Points are chosen randomly on each of the six side surfaces of the enveloping cuboid Qu(k). A straight line which is at right angles to the side surface and runs through the point is determined for each point. Because this straight line is at right angles to a side surface, it runs parallel to one coordinate axis, and therefore in the direction of one of the predetermined n direction vectors.

In FIG. 2, the component Bt(k) is a connection element with rounded edges. The cuboid Qu(k) is larger than the minimum envelop. FIG. 2 shows the selection of foot points for the direction vector −\vec{y}. Six points P-1, . . . , P-6 are selected randomly on the side surface SF which is at right angles to the direction vector −\vec{y} and is the closest side surface in the direction −\vec{y}. The sixth determined straight lines in FIG. 2, which are at right angles to the side surface SF and run through in each case one of the six points P-1, . . . , P-6 are represented by dashed lines.

For each of the cuboid points, the closest intersection of the straight line through the cuboid point with the surface of the design model KM(r) is determined, and is used as a foot point. It is possible for the straight line not to meet the design model KM(r), and therefore for there to be no intersection. If the straight line passes through the design model KM(r) and there are therefore a plurality of intersections with its surface, that intersection which is closest to the cuboid point is selected as the foot point. If the straight line intersects the design model KM(r) at a single point, then this single intersection is selected as the foot point. Four foot points FP-1, . . . , FP-4 are selected in the example in FIG. 2.

As described above, in addition to the six direction vectors \vec{x}, \vec{y}, \vec{z}, −\vec{x}, −\vec{y} and −\vec{z}, further direction vectors are predetermined in one embodiment, for example the six vectors \vec{x}+\vec{y}, \vec{x}+\vec{z}, \vec{y}+\vec{z}, −\vec{x}−\vec{y}, −\vec{x}−\vec{z} and −\vec{y}−\vec{z}. At least one further cuboid which envelops the design model KM(k) is calculated. Each of the six side surfaces of this further cuboid are at right angles either to \vec{x}+\vec{y}, to \vec{x}+\vec{z} or to \vec{y}+\vec{z}. The procedure described above is applied to this further cuboid in order to define additional foot points.

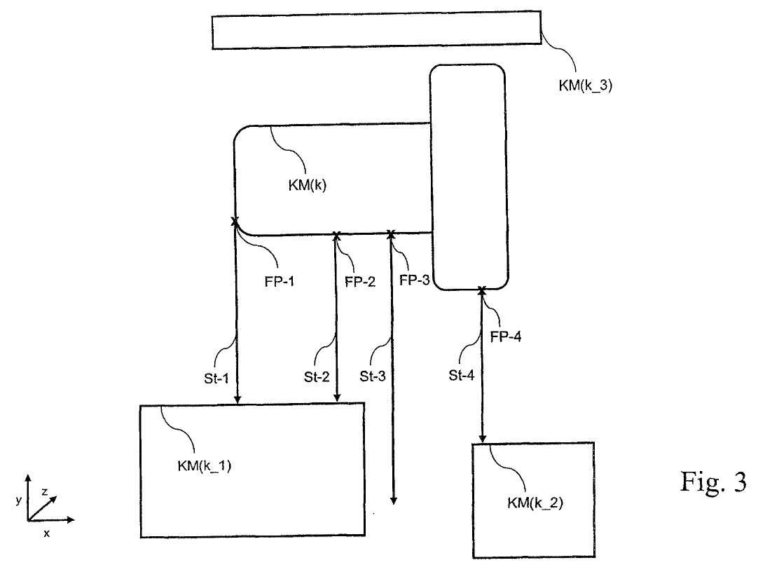

The vector from the foot point to the associated point on the side surface of the cuboid Qu(k) is calculated for each foot point selected in this way on the surface of the design model KM(k). This vector lies on the straight line calculated as described above, and runs in the direction of one of the r predetermined direction vectors [symbol] . FIG. 3 shows the calculation of four vectors for the direction vector −\vec{y}. These four vectors originate from the four foot points FP-1, . . . , FP-4 which have been selected for the direction vector −\vec{y}, and run in the direction of −\vec{y}.

The number of occasions on which these vectors run in the direction of the direction vector [symbol] is counted for each direction vector [symbol] (i=1, . . . , n). This number also depends on the design model KM(k). The calculated number for k=1, . . . , r and i=1, . . . , n is denoted N(k,i). N(k,i) vectors therefore start at one foot point on the surface of the design model KM(k) and run in the direction of the direction vector [symbol] . In the example shown in FIG. 3, four vectors run in the direction of the direction vector −\vec{y}, that is to say, in this example N(k,i)=4.

A lower limit N(i) is predetermined for the number N(k,i) of these vectors. This lower limit can vary from one direction vector to another and therefore depends on the index i. By way of example, a value of N(i)>=1 is predetermined. Alternatively, the maximum and the minimum extent of all of the components are calculated for each direction vector [symbol] (i=1, . . . , n) in a direction which is at right angles to [symbol] . d_max(i) denotes the maximum extent and d_min(i) the minimum extent. The limit N(i) is preferably predetermined such that

$$N ( i ) >= \frac{d\_max ( i )}{d\_min ( i )} .$$

If fewer vectors than the lower limit are counted for a direction vector [symbol] (i=1, . . . , n) then further vectors are calculated in the direction of this direction vector [symbol] . Further points are selected on a side surface which is at right angles to [symbol] . Further vectors are calculated using the procedure as described above. Once the currently described method step has been completed, then, for all k=1, . . . , r and i=1, . . . , n: N(k,i)>=N.

Each of the N(k,i) vectors is lengthened to form a ray. The ray starts at the same foot point of the design model KM(k) as the vector, and is (theoretically) of infinite length. In the example in FIG. 3, four rays St-1, . . . , St-4 are produced in this way in the direction of the direction vector −\vec{y}.

The number of N(k,i) rays which run in the direction of [symbol] and meet at least one design model KM(j) (j=1, . . . , r, j#k) of another component in the system are determined for each direction vector [symbol] . Let us assume that M(k,i) represents this calculated number of rays in the direction of [symbol] which originate from KM(k) and meet at least one other design model. In this case: 0<=M(k,i)<=N(k,i).

In the example in FIG. 3, the rays St-1 and St-2 both meet the design model KM(k_1) of another component Bt(k_1). The ray St-4 meets the design model KM(k_2) of a further different component Bt(k_2). The ray St-3 does not meet any design model of another component. The design model KM(k_3) is irrelevant for the direction vector −\vec{y}. In consequence, M(k,i)=3.

With the aid of the numbers M(k,i) and N(k,i), a weighting Wtg(k,i) is calculated for the component Bt(k) with respect to the direction vector [symbol] (k=1, . . . , r and i=1, . . . , n).

One embodiment provides for the weighting Wtg(k,i) to be calculated as a function of the quotient

$$\frac{M ( k , i )}{N ( k , i )} .$$

The weighting Wtg(k,i) is calculated such that Wtg(k,i)=1 when M(k,i)=0. This is because M(k,i) is equal to 0 when none of the rays which originate from KM(k) and run in the direction [symbol] meet another design model. The component Bt(k) can then be moved freely in the direction of [symbol] . If

$$M ( k , i ) >= N ( i ) >= \frac{d\_max ( i )}{d\_min ( i )} ,$$

then the design model of every other component which restricts the movement of Bt(k) in the direction [symbol] is met by at least one ray originating from KM(k). For example, the weighting of Bt(k) with respect to [symbol] is calculated by the calculation rule

$$Wtg ( k , i ) = 1 - \frac{M ( k , i )}{N ( k , i )} ,$$

or in general by the calculation rule

$$Wtg ( k , i ) = 1 - {[ \frac{M ( k , i )}{N ( k , i )} ]}^{a}$$

for k=1, . . . , r and i=1, . . . , n with an exponent α>0.

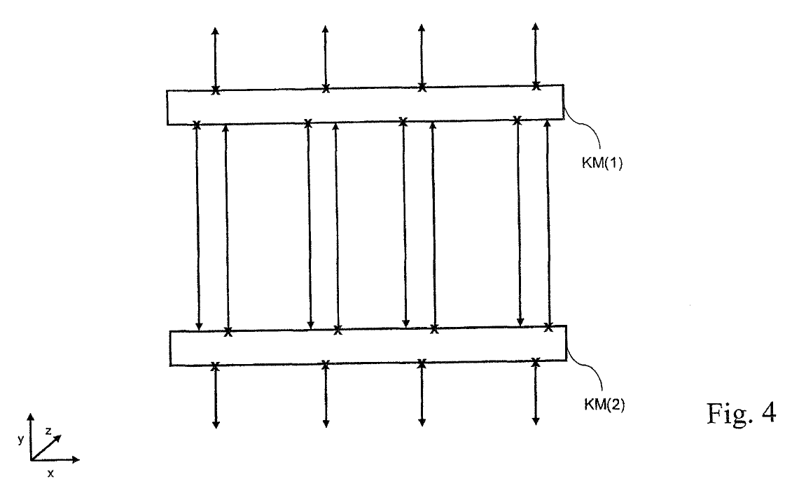

In the example shown in FIG. 4, six direction vectors are predetermined, including the direction vectors [symbol] =−\vec{y} and [symbol] =\vec{y}. The four rays which originate from the design model KM(1) in the direction of −\vec{y} in this example all meet the design model KM(2). None of the four rays which originate from the design model KM(1) in the direction of \vec{y} meet another design model. In consequence, N(1,1)=4, M(1,1)=4, N(1,4)=4, M(1,4)=0. None of the four rays which originate from the design model KM(2) in the direction of −\vec{y} meet another design model. The four rays which originate from the design model KM(2) in the direction of \vec{y} in this example all meet the design model KM(1), so that N(2,1)=4, M(2,1)=0, N(2,4)=4, M(2,4)=4. The following weightings are therefore calculated, independently of the value of α:

$$Wtg ( 1 , 1 ) = 1 - {[ \frac{M ( 1 , 1 )}{N ( 1 , 1 )} ]}^{a} = 0$$

$$Wtg ( 1 , 4 ) = 1 - {[ \frac{M ( 1 , 4 )}{N ( 1 , 4 )} ]}^{a} = 1$$

$$Wtg ( 2 , 1 ) = 1 - {[ \frac{M ( 2 , 1 )}{N ( 2 , 1 )} ]}^{α} = 1$$

$$Wtg ( 2 , 4 ) = 1 - {[ \frac{M ( 2 , 4 )}{N ( 2 , 4 )} ]}^{α} = 0$$

A second embodiment is dependent on the opposite vector −\vec{v} also being a direction vector when a vector \vec{v} is a direction vector. In this case, n is an even number. The direction vectors are numbered successively such that

$$\vec{r ( \frac{n}{2} + i )} = - \vec{r ( i )}$$

is

$$( i = 1 , … , \frac{n}{2} ) .$$

A factor α>0 is predetermined. n/2 weightings Wtg(k,i) with respect to the n/2 direction vectors

$${r ( 1 )}^{} , … , {r ( \frac{n}{2} )}^{}$$

are calculated to be precise using the calculation rule:

$$Wtg ( k , i ) = [ \frac{M ( k , \frac{n}{2} + i )}{N ( k , \frac{n}{2} + i )} - \frac{M ( k , i )}{N ( k , i )} ] * exp [ ( - α ) * min \{ \frac{M ( k , \frac{n}{2} + i )}{N ( k , \frac{n}{2} + i )} , \frac{M ( k , i )}{N ( k , i )} \} ]$$

(k=1, . . . , r, i=1, . . . , n/2). Wtg(k, i) is then a number between −1 and 1. In each case one weighting Wtg(k,i) of the component with respect to [symbol] is likewise calculated for

$$k = 1 , … , r , i = \frac{n}{2} + 1 , … , n ,$$

specifically by using the calculation rule

$$Wtg ( k , i ) = - Wtg ( k , i - \frac{n}{2} ) .$$

In the second embodiment, Wtg(k,i)=0 can be calculated for one value of i, even though M(k,i)=0, which means that the component Bt(k) can be moved freely in the direction of [symbol] . This is possible, for example, when

$$M ( k , \frac{n}{2} + i ) = M ( k , i )$$

for one value of i=1, . . . , n/2. Wtg(k,i)=1 is therefore preferably set when M(k,i)=0.

The following values are calculated in the example in FIG. 4, with n=6 and with the value for α once again not influencing the result:

$$\begin{matrix}Wtg ( 1 , 1 ) = [ \frac{M ( 1 , \frac{6}{2} + 1 )}{N ( 1 , \frac{6}{2} + 1 )} - \frac{M ( 1 , 1 )}{N ( 1 , 1 )} ] * \\ exp [ ( - α ) * min \{ \frac{M ( 1 , \frac{6}{2} + 1 )}{N ( 1 , \frac{6}{2} + 1 )} , \frac{M ( 1 , 1 )}{N ( 1 , 1 )} \} ] \\ = [ \frac{M ( 1 , 4 )}{N ( 1 , 4 )} - \frac{M ( 1 , 1 )}{N ( 1 , 1 )} ] * \\ exp [ ( - α ) * min \{ \frac{M ( 1 , 4 )}{N ( 1 , 4 )} , \frac{M ( 1 , 1 )}{N ( 1 , 1 )} \} ] \\ = [ \frac{0}{4} - \frac{4}{4} ] * exp [ ( - α ) * min \{ \frac{4}{4} , \frac{0}{4} \} ] \\ = - 1\end{matrix}$$

$$Wtg ( 1 , 4 ) = - Wtg ( 1 , 1 ) = 1$$

$$\begin{matrix}Wtg ( 2 , 1 ) = [ \frac{M ( 2 , \frac{6}{2} + 1 )}{N ( 2 , \frac{6}{2} + 1 )} - \frac{M ( 2 , 1 )}{N ( 2 , 1 )} ] * \\ exp [ ( - α ) * min \{ \frac{M ( 2 , \frac{6}{2} + 1 )}{N ( 2 , \frac{6}{2} + 1 )} , \frac{M ( 2 , 1 )}{N ( 2 , 1 )} \} ] \\ = [ \frac{M ( 2 , 4 )}{N ( 2 , 4 )} - \frac{M ( 2 , 1 )}{N ( 2 , 1 )} ] * \\ = exp [ ( - α ) * min \{ \frac{M ( 2 , 4 )}{N ( 2 , 4 )} , \frac{M ( 2 , 1 )}{N ( 2 , 1 )} \} ] \\ = [ \frac{4}{0} - \frac{0}{4} ] * exp [ ( - α ) * min \{ \frac{4}{4} , \frac{0}{4} \} ] \\ = 1\end{matrix}$$

$$Wtg ( 2 , 4 ) = - Wtg ( 2 , 1 ) = - 1$$

Next, an overall weighting Wtg(k) is additionally calculated for the component Bt(k) (k=1, . . . , r). The n calculated weightings (Wtg(k,1), . . . , Wtg(k,n) of the component Bt(k) with respect to the n direction vectors [symbol] are used for this purpose. The overall weighting Wtg(k) is calculated as the maximum weighting, using the calculation rule

$$Wtg ( k ) = {max}_{i = 1 , … , n} Wtg ( k , i ) .$$

Furthermore, the maximum overall weighting Wtg_max of the weightings of all r components is calculated using the calculation rule

$$Wtg\_max = {max}_{k = 1 , … , r} Wtg ( k ) .$$

That one of the r components Bt(1), . . . , Bt(r) which has this maximum weighting is determined. Therefore: Wtg_max=Wtg(k_1). The index k_1 of this component is defined such that

$$Wtg ( k\_ 1 ) = Wtg\_max = {max}_{k = 1 , … , r} Wtg ( k ) .$$

The index k_1 is a number between 1 and r.

A movement vector [symbol] is determined for the component Bt(k_1) that has been determined in this way. The direction vector Bt(k_1) with respect to which the greatest weighting was calculated is determined. The index i(k_1) of this direction vector is a number between 1 and n, and is defined such that

$$Wtg [ k\_ 1 , i ( k\_ 1 ) ] = {max}_{i = 1 , … , n} Wtg ( k\_ 1 , i ) .$$

The movement vector [symbol] is the same as the direction vector [symbol] . The maximum weighting Wtg_max is compared with a predetermined limit Δ. If Wtg_max>=Δ, then the result is determined and output that the component Bt(k_1) can be removed from the system in the direction of the movement vector [symbol] . If Wtg_max<Δ and therefore Wtg(k)<Δ for all values of k−1, . . . , r, then no component at all can be removed from the system, and the system is therefore not broken down into its components.

The method described above is applied once again to the reduced system, which has been created from the predetermined system by removal of the component Bt(k_1). The reduced system comprises r−1 components Bt(1), . . . , Bt(k_1−1), Bt(k_1+1), . . . , Bt(r). The reference to the design model KM(k_1) for the component Bt(k_1) is removed from the design model KM for the system. Weightings for the r−1 components with respect to the n direction vectors are calculated once again. r−1 overall weightings of the r−1 components are calculated from these weightings. The component Bt(k_2) with the greatest overall weighting as well as the movement vector [symbol] of this determined component Bt(k_2) are determined.

This process is repeated. After each run, the system is reduced by the respectively determined components. The repeated runs are ended when the system created by omission of the component determined in the previous run has only one component.

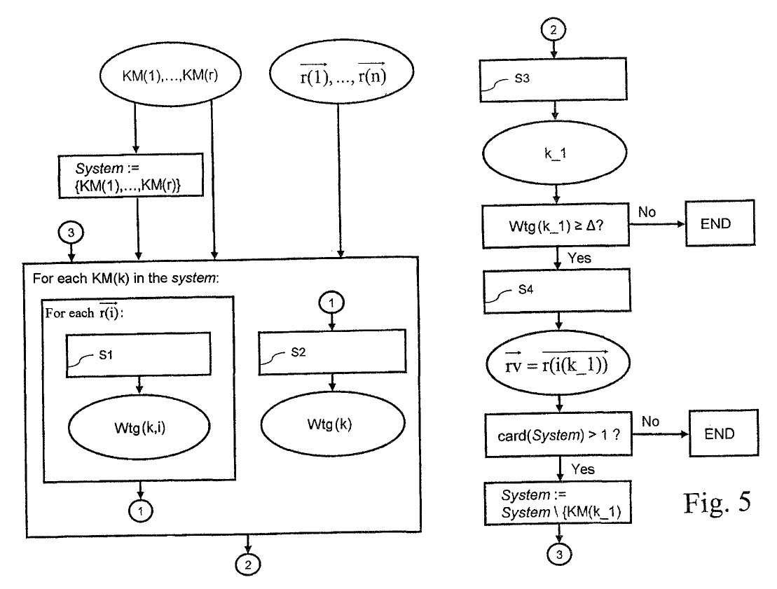

FIG. 5 shows the repeated running of the method according to the invention. The r design models KM(1), . . . , KM(r) as well as the n direction vectors [symbol] are predetermined. In the first run, the method is applied to the system which comprises the r design models KM(1), . . . , KM(r). A weighting Wtg(k,i) of KM(k) with respect to [symbol] is calculated for each design model KM(k) and for each direction vector [symbol] as described above, in step S1. In step S2, the overall weighting Wtg(k) of KM(k) is calculated with respect to the n direction vectors.

In step S3, the maximum overall weighting Wtg_max and the index k_1 of the component with this maximum overall weighting are determined. If Wtg_max=Wtg(k_1) is less than the limit Δ, the method is terminated. Otherwise, the movement vector [symbol] is determined in step S4.

When the system now comprises only one component, the method is ended. Otherwise, the method is carried out again, and is in this case applied to a system which has been reduced by the design model KM(k_1) of the previously determined component.

A break-down sequence is calculated for the system. This sequence indicates the sequence in which the system can be broken down into its components, as well as the respective direction vector, in which the component can be removed, for each component. The first element in the break-down sequence comprises the component Bt(k_1) determined in the first run and the movement vector [symbol] of Bt(k_1). By way of example, the component Bt(k_1) is identified by its index k_1, and the direction vector [symbol] is indicated by its index i(k_1). The second element in the break-down sequence comprises the component Bt(k_2) determined in the second run, and the movement vector [symbol] of Bt(k_2).

As mentioned above, the method is used to generate an exploded drawing. The method described above is carried out (r−1) times. In the first run, it is applied to the predetermined system with r components, with one component Bt(k_1) and one movement vector [symbol] for Bt(k_1) being determined. During each subsequent run, the method is applied to the system which has been created from the system from the previous run by omission of the component determined in the previous run. If the component Bt(k_m) is determined in the (m−1)-th run (m=2, . . . , r−1), then the method is applied to a reduced system, without the component Bt(k_m), in the m-th run.

Particularly when determining how many rays meet design models of other components of the system, the previously determined component Bt(k_m) is ignored. In the example shown in FIG. 3, the first run of the method has determined, as described above, that three of the four rays meet other design models, and therefore that M(k,i)=3. If the component Bt(k_1) with the design model KM(k_1) is determined in the first run, then the design model KM(k_1) and the fact that the rays St-1 and St-2 meet KM(k_1) are therefore ignored in the second run. If St-1 and St-2 do not meet any other design model either, then M(k,i)=1 in the second run.

The system which remains after the (r−1)-th run now has only one component, so that a further run would be pointless, and is not carried out.

As mentioned above, a component Bt(k_m) and a movement vector [symbol] are determined in the m-th run of the method (m=1, . . . , r−1). The design model KM(k_m) of the determined component Bt(k_m) is moved in the direction of the determined movement vector [symbol] . The design model KM(k_1) of the component Bt(k_1) which is determined in the first run is preferably moved through a predetermined distance in the direction [symbol] . In each subsequent (m+1)-th run (m=1, . . . , r−2), the design model KM(k_m+1) of the determined component Bt(k_m+1) is moved so far in the direction of [symbol] that, after the movement the design models KM(k_1), . . . , KM(k_m) the design models of the components Bt(k_1), . . . , Bt(k_m) which have been determined in the previous m run can be seen completely from the viewing direction. The most recently determined design model is, for example, not moved at all.

A perspective representation is produced for each of the r components. This representation that is produced illustrates the respective component from the predetermined viewing direction. The representation for the component Bt(k) (k=1, . . . , r) is produced using the moved design model KM(k). The representations that are produced are assembled to form the exploded drawing.

In a development of the exemplary embodiment, not only are the numbers M(k,i) of the relevant rays calculated, but the distance dist (j,k,i) (j=1, . . . , N(k,i)) between the foot point of the ray and the relevant design model of the other component is also calculated for each relevant ray. The calculated distance is the distance between the foot point and the closest intersection of the ray with the surface of the design model of the other component. The distance dist (j,k,i) is preferably included in the weighting Wtg(k,i) such that Wtg(k,i) becomes greater the greater dist (j,k,i) is. For example, the maximum spatial extent L(k,i) of the component Bt(k) (k=1, . . . , r) in the direction [symbol] is calculated, to be precise using the design model KM(r). The number of those rays for which L(k,i)>=dist(j,k,i) is used as the number M(k,i) of the relevant rays in the direction of [symbol] . These are the only rays for which a design model of another component is closer than the maximum extent of Bt(k) in the direction of [symbol] . Long distances, which are greater than the length of the component to be removed, are in this case provided with a lower weighting than short distances. This is because relatively short distances indicate collisions in the immediate vicinity of the component.

List of reference symbols used

| Symbol | Meaning |
|---|---|
| Wtg (i) | Overall weighting of Bt (k) |
| Wtg (k, i) | Weighting of Bt (k) with respect to |
| | [symbol] |
| Wtg_max | Maximum overall weighting of all |
| | components |
| Bt (1), . . . , Bt (r) | r components from which the system |
| | is assembled |
| Bt (k_m) | Component which has been |
| | determined in the m-th run of the |
| | method |
| d_max (i) | Maximum extent of all components |
| | in a direction at right angles to |
| | [symbol] |
| d_min (i) | Minimum extent of all components |
| | in a direction at right angles to |
| | [symbol] |
| dist (j, k, i) | Distance between a foot point of |
| | KM (k) and another design model |
| | measured in the direction of the |
| | ray j in the direction of [symbol] |
| FP-1, . . . , FP-4 | Foot points which have beeen |
| | selected for the direction vector |
| | -\vec{y} |
| i (k) | Index of the movement vector of |
| | the component Bt (k), at the same |
| | time as the index of that |
| | direction vector with the highest |
| | weighting with respect to Bt (k); |
| | $Wtg ( k , i ( k ) ) = {max}_{i = 1 , … , n} Wtg ( k , i )$ |
| k_1 | Index of component which has the |
| | greatest overall weighting in the |
| | first run of the method, and which |
| | is therefore determined |
| k_2 | Index of component which has the |
| | greatest overall weighting in the |
| | second run of the method |
| KM | Design model of the system |
| KM (k) | Design model of the component |
| | Bt (k) (k = 1, . . . , r) |
| M (k, i) | Number of rays in the direction of |
| | [symbol] which originate from KM (k) |
| | and meet at least one other design |
| | model |
| N | Number of predetermined direction |
| | vectors |
| N (i) | Predetermined minimum number of |
| | rays in the direction of [symbol] |
| N (k, i) | Number of rays which start at a |
| | foot point from KM (k) and run in |
| | the direction of [symbol] |
| P-1, . . . , P-6 | Points on the side surface SF of |
| | the cuboid Qu (k) which have been |
| | selected for the direction vector |
| | -\vec{y} |
| Qu (k) | Cuboid which completely envelops |
| | the design model KM (k) |
| | (k = 1, . . . , r) |
| R | Number of components in the system |
| [symbol] , . . . , [symbol] | Predetermined direction vectors |
| [symbol] | Movement vector of the determined |
| | component Bt (k_m) (m = 1, . . . , r-1) |
| [symbol] | Movement vector |
| S (1) | Calculation of Wtg (k, i) |
| S (2) | Calculation of Wtg (k) |
| S (3) | Determined of the index k_i |
| S (4) | Determination of the movement |
| | vector [symbol] |
| St-1, . . . , St-4 | Rays in direction of the |
| | direction vector -\vec{y} |
| \vec{x}, \vec{y} and \vec{z} | Axes of a predetermined Cartesian |
| | coordinate system |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-23. (canceled)

24. A method for determining how to break down a technical system into its individual components in which a computer-available design model of the system is predetermined, one computer-available three-dimensional design model of each component of the system is predetermined, and a plurality of direction vectors are predetermined, wherein the method comprises the steps of:
determining which of the direction vectors of the design model meet at least one other component;
determining the directions in which a component can be removed from the system as a function of the result of the determination process,
selecting, for each component, a plurality of points in the design model of the component as foot points;
calculating a ray for each component and each selected foot point, starting at the foot point and running in the direction of a direction vector;
determining, for each component and each selected foot point and each direction vector, the number of rays in the design model of at least one other component which start at the foot point, run in the direction of the direction vector and meet;
calculating a weighting of the component for each direction vector as a function of
the determined number of rays which meet a different design model in the direction of the direction vector, and
the number of rays produced in total in the direction of the direction vector,
calculating an overall weighting of the component as a function of the weightings of the component with respect to the direction vectors,
determining those components which have the greatest weighting of all the calculated weightings with respect to which direction vector,
determining as a movement vector of the determined component of that direction vector with respect to which the determined component has the greatest weighting, and
removing the selected component from the system in the direction of the movement vector.

25. The method as claimed in claim 24, wherein each predetermined component design model comprises node points in a network of the surface of the respective component design model, and node points in the network are selected as foot points of the design model of the component.

26. The method as claimed in claim 24, wherein the method comprises the steps of:
determining, for each direction vector, a plane which is at right angles to the direction vector;
selecting points on this plane;
calculating, for each selected point, one straight line which runs through that point and is at right angles to the plane; and
selecting, as foot points for each component, at least one intersection of each straight line with the design model of the component.

27. The method as claimed in claim 24, wherein a three-dimensional coordinate system is predetermined, the three vectors in the direction of the three axes of the coordinate system are predetermined as direction vectors, and the three vectors in the opposite directions are predetermined as direction vectors.

28. The method as claimed in claim 27, comprising the steps of:
determining, for each component, a cuboid whose side surfaces are at right angles to in each case one axis of the coordinate system and which completely surrounds the design model of the component;
selecting a plurality of points on each side surface of the cuboid;
defining, for each selected point on a side surface, a straight line through the point which is at right angles to the side surface is defined;
and, if the straight line meets the design model of the component, selecting that intersection of the straight line with the design model which is closest to the side surface is selected as the foot point for that component.

29. The method as claimed in claim 24, wherein
each design model for a component is predetermined such that it defines the geometry of the surface of the component, and
the design model of the system is predetermined such that it defines the positions of the components relatively to one another in the system.

30. The method as claimed in claim 24, wherein the weighting of a component with respect to a direction vector is calculated as a function of the quotient of the number of rays which meet and the number of selected foot points.

31. The method as claimed in claim 24, wherein
for each selected foot point when the ray which starts at the foot point meets another design model, the distance between that foot point and the other design model is determined, and
the weighting of each component with respect to each direction vector is calculated as a function of the respectively determined distances.

32. The method as claimed in claim 24, wherein when it is determined for a direction vector that none of the rays running in the direction of this direction vector meets the design model of another component, removing the component from the system in the direction of that direction vector.

33. The method as claimed in claim 24, comprising the step of:
selecting for each component the greatest weighting of the weightings of the component with respect to the direction vectors and using the selected weighting as the overall weighting for that component.

34. The method as claimed in claim 24, wherein it is determined that the system cannot be broken down into its components when the overall weighting of each component is less than a predetermined limit.

35. The method as claimed in claim 24, wherein for each selected foot point, for each direction vector and for each selected foot point, when a ray which starts at the foot point meets a design model of another component in the direction of the direction vector, the method comprises the steps of:
determining the distance between that foot point and the relevant design model; and
calculating, as a function of the determined distances, the weighting of that component with respect to each direction vector.

36. The method of claim 24, wherein the method is carried out a plurality of times successively, and, in the process is applied to the predetermined system in a first run, and is applied in each subsequent run to the system which is created from the system from the previous run by omission of the component determined in the previous run, and
wherein the repeated running ends when the system which results from omission of the component determined in the previous runs has only one component.

37. The method of claim 24, wherein the method is carried out a plurality of times successively, and, in the process, is applied to the predetermined system in a first run and the component with the highest overall weighting being determined as the first component in the break-down sequence, and is applied in each subsequent run to the system which is created from the system from the previous run by omission of the component determined in the previous run, and
wherein the component for which the highest overall weighting is calculated in the subsequent run is inserted into the break-down sequence as the successor to the currently last component, and the repeated running is ended when the system which results from omission of the component determined in the previous run has only one component.

38. The method of claim 37, wherein the reverse break-down sequence is calculated as the assembly sequence.

39. The method of claim 24, wherein a viewing direction is predetermined, and the method is carried out repeatedly and successively, and, during this process, is applied to the predetermined system in a first run, and is applied in each subsequent run to the system which is formed from the system in the previous run by omission of the component determined in the previous run,
wherein in each run of the method, the design model of the determined component is moved in the direction of the determined movement vector,
wherein the process of carrying out the method repeatedly is ended when the system which is obtained by omission of the component determined in the previous run has only one component,
wherein the representation of the component from the viewing direction is produced for each component, using the moved design model, and
wherein the representations that are produced of all of the components are assembled to form the exploded drawing.

40. The method as claimed in claim 39, wherein the design model of the first component in the break-down sequence is moved to a predetermined distance and the design model of each subsequent component in the break-down sequence is moved so far that, after the move, all of the design models of the components determined in the previous runs can be seen completely from the viewing direction.

41. The method as claimed in claim 36, wherein the method is terminated when an overall weighting below a predetermined limit has been calculated for all the components in the system in the previous run.

42. A computer program product which is loaded in the internal memory of a computer and has software section to perform the steps of:
determining which of the direction vectors of the design model meet at least one other component;
determining the directions in which a component can be removed from the system as a function of the result of the determination process,
selecting, for each component, a plurality of points in the design model of the component as foot points;
calculating a ray for each component and each selected foot point, starting at the foot point and running in the direction of a direction vector;
determining, for each component and each selected foot point and each direction vector, the number of rays in the design model of at least one other component which start at the foot point, run in the direction of the direction vector and meet;
calculating a weighting of the component for each direction vector as a function of
the determined number of rays which meet a different design model in the direction of the direction vector, and
the number of rays produced in total in the direction of the direction vector,
calculating an overall weighting of the component as a function of the weightings of the component with respect to the direction vectors,
determining those components which have the greatest weighting of all the calculated weightings with respect to which direction vector,
determining as a movement vector of the determined component of that direction vector with respect to which the determined component has the greatest weighting, and
removing the selected component from the system in the direction of the movement vector.

43. A computer program product which is stored on a computer-legible medium and has a computer-readable program which causes a computer to carry out the steps of:
determining which of the direction vectors of the design model meet at least one other component;
determining the directions in which a component can be removed from the system as a function of the result of the determination process,
selecting, for each component, a plurality of points in the design model of the component as foot points;
calculating a ray for each component and each selected foot point, starting at the foot point and running in the direction of a direction vector;
determining, for each component and each selected foot point and each direction vector, the number of rays in the design model of at least one other component which start at the foot point, run in the direction of the direction vector and meet;
calculating a weighting of the component for each direction vector as a function of
the determined number of rays which meet a different design model in the direction of the direction vector, and
the number of rays produced in total in the direction of the direction vector,
calculating an overall weighting of the component as a function of the weightings of the component with respect to the direction vectors,
determining those components which have the greatest weighting of all the calculated weightings with respect to which direction vector,
determining as a movement vector of the determined component of that direction vector with respect to which the determined component has the greatest weighting, and
removing the selected component from the system in the direction of the movement vector.

44. A computer program product which has read access to a data memory, that stores a computer-available design model of a technical system, a computer-available three-dimensional design model for each component of the system, and computer-available definitions of a plurality of direction vectors in which the computer program of product performs the steps of:
determining which of the direction vectors meet the design model of at least one other component, and
determining the directions in which a component can be removed from the system as a function of the result of the determination process,
selecting, for each component, a plurality of points in the design model of the component as foot points,
calculating, for each component and for each selected foot point, a ray which starts at the foot point and runs in the direction of a direction vector,
determining, for each component, for each selected foot point and for each direction vector, how many rays which start at the foot point and run in the direction of the direction vector meet the design model of at least one other component,
calculating a weighting for each component with respect to each direction vector as a function of the determined number of rays in the direction of the direction vector which meet another design model, and the total number of rays produced in the direction of the direction vector,
calculating an overall weighting of the component as a function of the weightings of the component with respect to the direction vectors,
determining a direction vector which has the highest weighting with respect to the determined component as the movement vector for the determined component, and
outputting a result that the determined component can be removed from the system in the direction of the movement vector.

45. A data processing installation which has read access to a data memory, that stores a computer-available design model of a technical system, a computer-available three-dimensional design model for each component of the system, and computer-available definitions of a plurality of direction vectors in which the computer program of product performs the steps of:
determining which of the direction vectors meet the design model of at least one other component, and
determining the directions in which a component can be removed from the system as a function of the result of the determination process,
selecting, for each component, a plurality of points in the design model of the component as foot points,
calculating, for each component and for each selected foot point, a ray which starts at the foot point and runs in the direction of a direction vector,
determining, for each component, for each selected foot point and for each direction vector, how many rays which start at the foot point and run in the direction of the direction vector meet the design model of at least one other component,
calculating a weighting for each component with respect to each direction vector as a function of the determined number of rays in the direction of the direction vector which meet another design model, and the total number of rays produced in the direction of the direction vector,
calculating an overall weighting of the component as a function of the weightings of the component with respect to the direction vectors,
determining a direction vector which has the highest weighting with respect to the determined component as the movement vector for the determined component, and
outputting a result that the determined component can be removed from the system in the direction of the movement vector.
